(19) United States
(12) Patent Application Publication
(10) Pub. No.: US 2003/0085548 A1
(43) Pub. Date: May 8, 2003

(54) Hitch pad

(76) Inventor: Christopher C. Morgan, Shreveport, LA (US)

Correspondence Address: R. Keith Harrison, 2139 E. Bert Kouns, Shreveport, LA, 71105, US

(21) Appl. No.: 09/992,187

(22) Filed: Nov. 5, 2001

(51) Int. Cl. B60D 1/00

(52) U.S. Cl. 280/507

(57) ABSTRACT

A hitch pad including a substantially resilient pad body having a bottom portion, a top portion carried by the bottom portion, a pad recess defined between the bottom portion and the top portion, a recess opening disposed between the bottom portion and the top portion and communicating with the pad recess, a top opening provided in the top portion, and a bottom opening provided in the bottom portion.

### BACKGROUND OF THE INVENTION

1. Field of the Invention

This invention relates to covers or cushions for trailer hitches and more particularly, to a hitch pad including a substantially resilient pad body having a bottom portion; a top portion carried by the bottom portion; a pad recess defined between the bottom portion and the top portion; a recess opening disposed between the bottom portion and the top portion and communicating with the pad recess; a top opening provided in the top portion; and a bottom opening provided in the bottom portion.

Boat and utility trailers are towed behind pickup trucks or other towing vehicles, which are commonly fitted with a rearwardly-extending hitch bar fitted with a hitch ball for receiving the forwardly-extending tongue-type hitch on the trailer. When the trailer hitch is uncoupled from the hitch ball, it is common for persons loading or unloading items in the back of the pickup truck or other vehicle to inadvertently bump their knees or shins on the hitch bar, resulting in much pain and sometimes, injury.

A number of devices are known in the art for cushioning a hitch ball or other hitch receiver to prevent inadvertent accidental striking by persons in the vicinity of the hitch ball or hitch receiver. Patents of interest in this regard are U.S. Pat. Nos. 3,596,926; 5,037,122; 5,533,743; 5,651,559; 5,791,677; and 6,039,339.

### SUMMARY OF THE INVENTION

A hitch pad including a substantially resilient pad body having a bottom portion, a top portion carried by the bottom portion, a pad recess defined between the bottom portion and the top portion, a recess opening disposed between the bottom portion and the top portion and communicating with the pad recess, a top opening provided in the top portion, and a bottom opening provided in the bottom portion.

### BRIEF DESCRIPTION OF THE DRAWINGS

The invention will be better understood by reference to the accompanying drawings, wherein:

FIG. 1 is a front view of an illustrative embodiment of the hitch pad of this invention;

FIG. 2 is a side view of the hitch pad;

FIG. 3 is a top view of the hitch pad;

FIG. 4 is an exploded, perspective view of the hitch pad, more particularly illustrating a typical two-piece construction of the hitch pad;

FIG. 5 is a longitudinal sectional view of the hitch pad, with the hitch pad shown provided on a hitch bar (in phantom) in typical application of the hitch pad;

FIG. 6 is a rear view of the hitch pad;

FIG. 7 is a perspective view of the hitch pad, more particularly illustrating a typical one-piece construction of the hitch pad;

FIG. 8 is a transverse sectional view, taken along section lines 8-8 in FIG. 7, with the hitch pad shown provided on a hitch bar (in phantom) in typical application of the hitch pad;

FIG. 9 is an exploded, perspective view of a hitch ball hitch assembly, more particularly illustrating typical installation of the hitch pad on a hitch bar in typical application of the hitch pad;

FIG. 10 is a transverse sectional view, taken along section lines 10-10 in FIG. 7, of another illustrative embodiment of the hitch pad of this invention; and

FIG. 11 is a transverse sectional view of another embodiment of the hitch pad of this invention, in typical application of the hitch pad.

### DESCRIPTION OF THE EMBODIMENTS

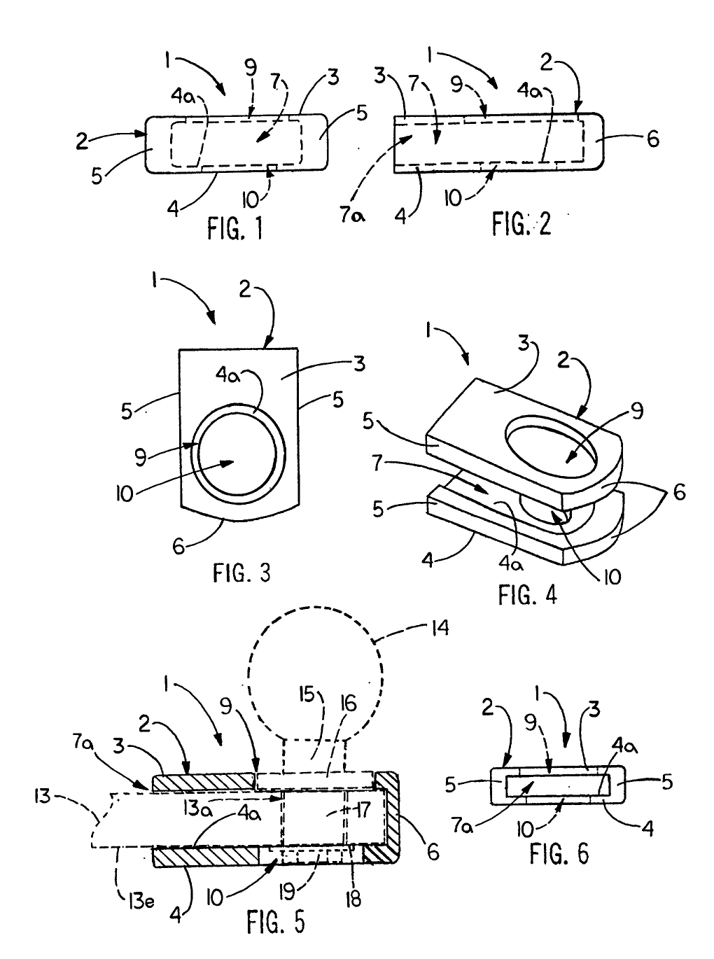

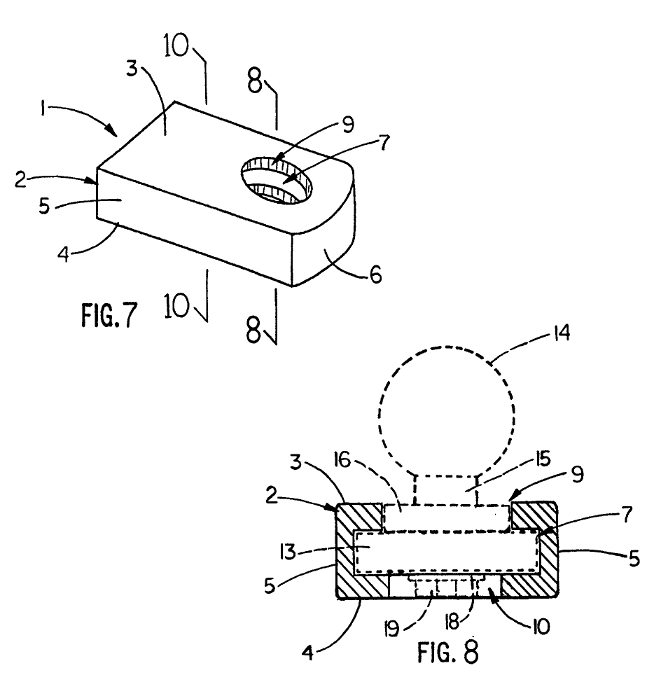

Referring initially to FIGS. 1-4, 6, 7 and 10 of the drawings, an illustrative embodiment of the hitch pad of this invention is generally indicated by reference numeral 1. The hitch pad 1 includes a pad body 2 which is constructed of a resilient material such as soft rubber, sponge material, polyurethane foam rubber, silicone elastomers or other soft plastic, in non-exclusive particular. Accordingly, the pad body 2 is typically constructed by molding, particularly injection-molding, or by cutting and assembly from sheets of resilient material or by other techniques known to those skilled in the art. A pair of pad sides 5 and a pad front 6 typically join a top portion 3 to a bottom portion 4, and a hitch recess 7 is defined between the top portion 3 and the bottom portion 4. As illustrated in FIG. 4, the pad side 5 and pad front 6 segments of the top portion 3 may be glued or otherwise attached to those respective segments of the bottom portion 4, or alternatively, the pad sides 5 and pad front 6 may be formed in one piece with the top portion 3 and bottom portion 4, as illustrated in FIG. 7. It is understood that the pad sides 5 and pad front 6 shown in the drawings represent only one structural example of mounting the top portion 3 on the bottom portion 4. In an alternative embodiment (not illustrated) of the hitch pad 1, the top portion 3 is attached directly to or molded integrally with the bottom portion 4 along the side and front edges of each to define an elastic, resilient sleeve-like configuration of the pad body 2. In both embodiments, a hitch recess 7 is defined between the top portion 3 and the bottom portion 4 and, as illustrated in FIGS. 2 and 6, a recess opening 7a is defined between the top portion 3, the bottom portion 4 and the pad sides 5 in oppositely-disposed relationship to the pad front 6, which recess opening 7a establishes communication between the hitch recess 7 and the exterior of the pad body 2 for purposes which will hereinafter become apparent. As illustrated in FIG. 4, a hitch bar seat 4a, the purpose of which will be hereinafter described, is defined by the pad sides 5 and the pad front 6 on the interior surface of the bottom portion 4. A top opening 9 extends through the top portion 3, and a bottom opening 10 in like manner extends through the bottom portion 4, which top opening 9 is typically disposed in substantially registering or aligned relationship with respect to the bottom opening 10. As illustrated in FIG. 10, a polyvinylchloride (PVC) or other plastic coating 8 may be provided on the exterior surface of the pad body 2 by dipping, spraying or other techniques known to those skid in the art for imparting protection, durability and enhanced appearance to the pad body 2. Alternatively, the plastic coating 8 may be omitted from the pad body 2.

Referring next to FIG. 9 of the drawings, in typical application the hitch pad 1 is provided on a hitch bar 13 extending rearwardly from a towing vehicle (not illustrated) to cushion and therefore, prevent pain and injury resulting from a person's inadvertently striking the hitch bar 13 typically with his or her knees or shins. The hitch bar 13 is typically fitted with a removable hitch ball 14, which nay have a downwardly-extending hitch ball neck 15 typically fitted with a circular hitch ball flange 16. A threaded hitch ball shaft 17 extends downwardly from the hitch ball flange 16 and normally extends through a shaft opening 13a provided in the hitch bar 13. A washer 18 is inserted on the lower portion of the hitch ball shaft 17, which receives a nut 19 that secures the flange 16 and the washer 18 against respective upper and lower surfaces of the hitch bar 13 to removably secure the hitch ball 14 on the hitch bar 13.

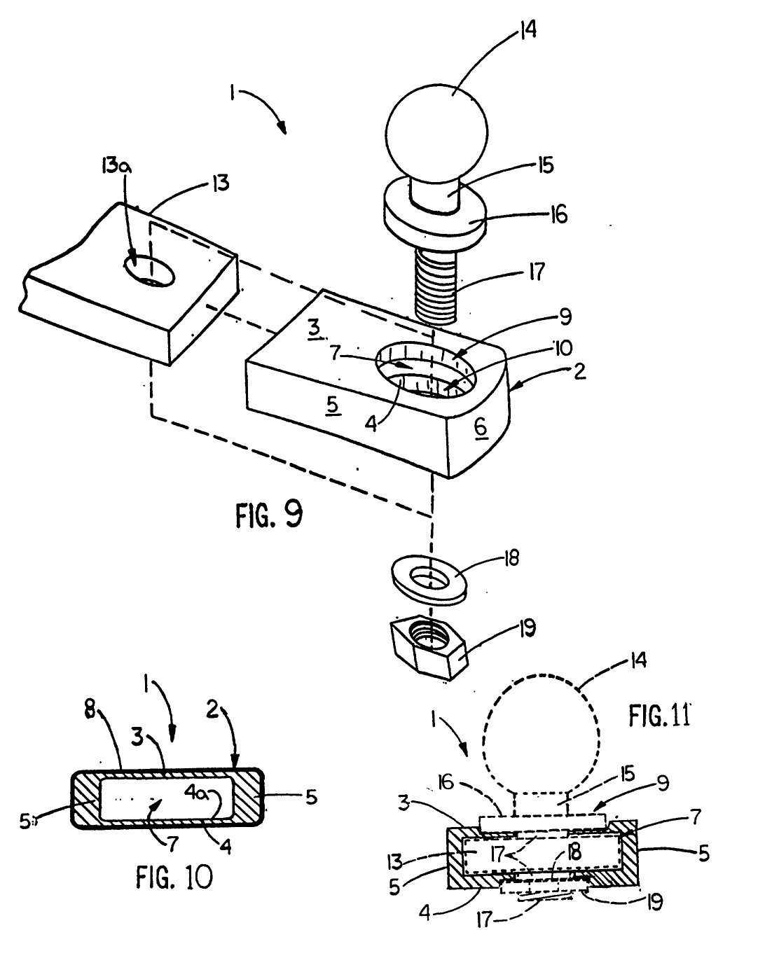

Referring next to FIGS. 5 and 8 and again to FIG. 9 of the drawings, the pad body 2 of the hitch pad 1 is installed on the hitch bar 13 by initially removing the hitch ball 14 and associated components from the hitch bar 13. This is normally accomplished by first removing the nut 19 and washer 18 from the threaded hitch ball shaft 17 and then removing the hitch ball shaft 17 from the shaft opening 13a in the hitch bar 13. The pad body 2 is then positioned on the hitch bar 13 by inserting the hitch bar 13 through the recess opening 7a (FIG. 2) and sliding the pad body 2 on the hitch bar 13 until the hitch bar 13 traverses the entire length of the hitch recess 7 and the front end of the hitch bar 13 abuts against the interior surface of the pad front 6 of the pad body 2, as illustrated in FIG. 5. Accordingly, both the top opening 9 and the bottom opening 10 of the pad body 2 are disposed in substantial registering or aligned relationship with respect to the shaft opening 13a of the hitch bar 13, as further illustrated in FIG. 9. Next, the hitch ball shaft 17 is extended downwardly through the top opening 9 of the top portion 3, the shaft opening 13a of the hitch bar 13 and the bottom opening 10 of the bottom portion 4, as further illustrated in FIG. 9. Finally, the washer 18 is inserted on the hitch ball shaft 17 and the nut 19 is threaded on the hitch ball shaft 19 and against the washer 18 to secure the washer 18 against the bottom surface of the hitch bar 13 and tighten the hitch ball flange 16 against the top surface of the hitch bar 13. It will be appreciated from a consideration of FIGS. 5 and 8 that the top opening 9 of the top portion 3 of the pad body 2 typically accommodates the hitch ball flange 16, whereas the bottom opening 10 of the bottom portion 4 typically accommodates the washer 18 and the securing nut 19. Accordingly, the pad body 2 of the hitch pad 1, held in place typically by the hitch ball flange 16 and the hitch bar 13, is positioned for cushioning inadvertent or accidental blows of a person's knees, shins or other body parts against the hitch bar 13 to prevent pain and possible injury resulting from such blows. Removal of the hitch body 2 from the hitch bar 13 is facilitated, as desired, by unthreading the securing nut 19 from the hitch ball shaft 17, removing the hitch ball shaft 17 from the shaft opening 13a of the hitch bar 13 and the top opening 9 and bottom opening 10 of the pad body 2, and removing the pad body 2 from the hitch bar 13.

Referring next to FIG. 11 of the drawings, in yet another embodiment of the hitch pad 1, the top opening 9 (FIG. 9) of the top portion 3 and the bottom opening 10 of the bottom portion 4 of the pad body 2 are substantially equal in diameter and each is sized to receive the threaded hitch ball shaft 17 of the hitch ball 14. In application, the hitch ball shaft 17 extends through the top opening 9 and the bottom opening 10 of the pad body 2 and through the registering shaft opening 13a of the hitch bar 13. The lower end of the hitch ball shaft 17 receives the washer 18 and the nut 19. Upon tightening the nut 19 on the hitch ball shaft 17, the top portion 3 of the pad body 2 is compressed between the hitch ball flange 16 and the upper surface of the hitch bar 13, whereas the bottom portion 4 of the pad body 2 is compressed between the washer 18 and the bottom surface of the hitch bar 13.

It is understood that the pad body 2 of the hitch pad 1 may have sharp or tapered corners and edges as illustrated in FIG. 7, or more rounded corners and edges as illustrated in cross-section in FIGS. 1 and 2. It will be appreciated by those skilled in the art that the pad body 2 can be constructed of substantially any desired resilient material known to those skilled in the art, and the pad body 2 can be constructed in any desired size and configuration such that the hitch recess 7 of the pad body 2 will accommodate a hitch bar 13 of a particular configuration and size. Accordingly, the length of the pad body 2 can be selected such that either a selected length or the entire length of the hitch bar 13 is covered and cushioned by the pad body 2. Referring again to FIG. 10 of the drawings, it is further understood that the pad body 2 may be covered in a vinyl cover or sheath (not illustrated) instead of the plastic coating 8, for protecting and/or enhancing the appearance of the pad body 8. Referring again to FIGS. 5 and 10, the thicknesses of the top portion 3, the bottom portion 4, the pad sides 5 and the pad front 6 can be chosen depending upon the desired cushioning effect, with greater thicknesses of those elements facilitating a correspondingly greater cushioning effect on the hitch bar 13.

While various illustrative embodiments of the invention have been described above, it will be recognized and understood that various modifications can be made in the invention and the appended claims are intended to cover all such modifications which may fall within the spirit and scope of the invention.

Having described my invention with the particularity set forth above, I claim:

1. A hitch pad for cushioning a hitch bar fitted with a hitch ball having a hitch ball shaft, said hitch pad comprising:
a pad body comprised of a substantially resilient material and comprising a bottom portion, a top portion carried by said bottom portion, a hitch recess defined between said bottom portion and said top portion, a recess opening defined between said bottom portion and said top portion and communicating with said hitch recess, a top opening provided in said top portion, and a bottom opening provided in said bottom portion; and
wherein said recess opening and said hitch recess are adapted for receiving the hitch bar and said top opening and said bottom opening of said pad body are adapted for receiving the hitch ball shaft of the hitch ball in mounting the hitch ball on the hitch bar.

2. The hitch pad of claim 1 comprising pad sides and a pad front joining said bottom portion and said top portion, and wherein said recess opening is disposed opposite said pad front.

3. The hitch pad of claim 1 wherein said substantially resilient material is rubber, foam rubber, sponge or plastic.

4. The hitch pad of claim 3 comprising pad sides and a pad front joining said bottom portion and said top portion, and wherein said recess opening is disposed opposite said pad front.

5. The hitch pad of claim 1 comprising a plastic coating provided on said pad body.

6. The hitch pad of claim 5 comprising pad sides and a pad front joining said bottom portion and said top portion, and wherein said recess opening is disposed opposite said pad front.

7. The hitch pad of claim 5 wherein said substantially resilient material is rubber, foam rubber, sponge or plastic.

8. The hitch pad of claim 7 comprising pad sides and a pad front joining said bottom portion and said top portion, and wherein said recess opening is disposed opposite said pad front.

9. A hitch pad and hitch device combination, comprising:
a hitch bar;
a hitch ball shaft carried by said hitch bar;
a hitch ball carried by said hitch ball shaft; and
a pad body comprised of a substantially resilient material carried by said hitch bar, said pad body comprising a bottom portion, a top portion carried by said bottom portion, a hitch recess defined between said bottom portion and said top portion, a recess opening communicating with said hitch recess, a top opening provided in said top portion and a bottom opening provided in said bottom portion;
wherein said hitch bar extends through said recess opening into said hitch recess of said pad body; and
wherein said hitch ball shaft extends through said top opening of said top portion and said bottom opening of said bottom portion.

10. The combination of claim 9 comprising a hitch ball flange provided on said hitch ball shaft and wherein said top portion of said pad body is compressed between said hitch ball flange and said hitch bar.

11. The combination of claim 9 comprising a washer and a nut provided on said hitch ball shaft and wherein said bottom portion of said pad body is compressed between said washer and said hitch bar.

12. The combination of claim 11 comprising a hitch ball flange provided on said hitch ball shaft and wherein said top portion of said pad body is compressed between said hitch ball flange and said hitch bar.

13. The combination of claim 9 wherein said pad body comprises pad sides and a pad front joining said bottom portion and said top portion, and wherein said recess opening is disposed opposite said pad front.

14. The combination of claim 9 comprising a hitch ball flange provided on said hitch ball shaft and wherein said hitch ball flange is disposed in said top opening of said top portion.

15. The combination of claim 9 comprising a nut threaded on said hitch ball shaft and wherein said nut is disposed in said bottom opening of said bottom portion.

16. The combination of claim 13 comprising a hitch ball flange provided on said hitch ball shaft and wherein said hitch ball flange is disposed in said top opening of said top portion, and comprising a nut threaded on said hitch ball shaft and wherein said nut is disposed in said bottom opening of said bottom portion.

17. The combination of claim 9 wherein said substantially resilient material is rubber, foam rubber, sponge or plastic.

18. The combination of claim 9 comprising a plastic coating provided on said pad body.

19. A method of cushioning a hitch bar having a shaft opening for removable receiving a hitch ball shaft of a hitch ball said method comprising:
providing a substantially resilient pad body comprising a bottom portion having a bottom opening, a top portion carried by said bottom portion and having a top opening, a hitch recess defined between said bottom portion and said top portion, and a recess opening communicating with said hitch recess;
removing the hitch ball shaft of the hitch ball from the shaft opening of the hitch bar;
positioning said pad body on the hitch bar by inserting the hitch bar through said recess opening into said hitch recess of said pad body, wherein said top opening and said bottom opening of said pad body are disposed in substantially registering relationship with respect to the shaft opening of the hitch bar; and
replacing the hitch ball on the hitch bar by extending the hitch ball shaft through said top opening of said pad body, the shaft opening of the hitch bar and said bottom opening of said pad body, respectively, and fastening the hitch ball shaft to the hitch bar.

20. The method of claim 19 comprising providing a plastic coating on said pad body.

21. The method of claim 19 comprising providing a pair of pad sides and a pad front connecting said bottom portion and said top portion of said pad body.

22. The method of claim 21 comprising providing a plastic coating on said pad body.
